(19) United States
(12) Patent Application Publication
(10) Pub. No.: US 2026/0043496 A1
(43) Pub. Date: Feb. 12, 2026

(54) PIPE CLAMPING APPLIANCE AND PIPE CLAMPING METHOD

(71) Applicant: NIPPON TELEGRAPH AND TELEPHONE CORPORATION, Tokyo (JP)

(72) Inventors: Takuya ISHIKAWA, Tokyo (JP); Koji ITASAKA, Tokyo (JP); Toshimitsu IZUMI, Tokyo (JP); Daisaku NISHIYAMA, Tokyo (JP)

(73) Assignee: NIPPON TELEGRAPH AND TELEPHONE CORPORATION, Tokyo (JP)

(21) Appl. No.: 19/100,201

(22) PCT Filed: Aug. 3, 2022
(86) PCT No.: PCT/JP2022/029850

§ 371 Date: Jan. 31, 2025

(51) Int. Cl. F16L 3/10

(52) U.S. Cl. CPC F16L 3/1016; F16L 3/1091; F16L 2201/20

(57) ABSTRACT

A pipe clamping tool (10) includes a pair of fixing members (11) that are each fixed to a side wall of an ground space and are arranged opposite to each other to clamp a pipe, and a covering material (12) mounted between the pair of fixing members (11) and the pipe and covering an outer periphery of the pipe.

### TECHNICAL FIELD

The present disclosure relates to a pipe clamping tool and a pipe clamping method.

### BACKGROUND ART

In recent years, for the purpose of achieving carbon neutrality by decarbonization and in order to utilize hydrogen gas, a method for supplying hydrogen gas and the safety in supplying hydrogen gas have been studied (see NPL 1).

Conventionally, a hydrogen pipeline for supplying hydrogen gas has been directly buried in the excavated ground. Therefore, expansion and contraction of the hydrogen pipe (hydrogen piping) are not generated by the binding force of soil when the hydrogen gas is forcibly fed.

FIG. 8 is a diagram for explaining an example of a hydrogen pipeline laid through a plurality of underground spaces. Conventionally, in addition to the above-mentioned hydrogen pipeline directly buried in the ground, a pipeline laid through a plurality of underground spaces has been introduced as shown in FIG. 8. The hydrogen pipe is laid in an empty pipeline inside an existing pipe connecting the plurality of underground spaces, and a hydrogen pipeline in which the plurality of hydrogen pipes are joined is constructed. In such a hydrogen pipeline, hydrogen gas is transported and supplied from the hydrogen tank on the supply side to the hydrogen tank on the demand side. Further, in order to cope with unevenness (surface is not horizontal but uneven) of the pipeline of the existing pipe) and curved construction or the like inside the existing pipe or the underground spaces, a flexible pipe which is light in weight and has a lot of flexibility is adopted as the hydrogen pipe. The flexible pipe is composed of a stainless steel corrugated raw pipe or the like, and is a lightweight, flexible pipe. In the underground spaces, a fixture is installed in the underground spaces in order to prevent bending of the flexible pipe which flexibly expands and contracts.

### CITATION LIST

### Non Patent Literature

[NPL 1] Tetsushi Morita, “Approaches to Hydrogen Pipeline Supply in City Gas Industry,” Journal of the Institute of

Electrical Installation Engineers of Japan, Vol. 36, No. 4, P. 242-245, 2016.

### SUMMARY OF INVENTION

### Technical Problem

However, when hydrogen gas is forcibly fed to the flexible pipe in an underground space having no binding force such as soil, the flexible pipe is extended by the pressure of the hydrogen gas, possibly causing buckling. In the worst case, the buckling of the flexible pipe may lead to an explosion accident caused by the opening of a hole in the pipe. FIG. 9 is a diagram showing the occurrence of buckling of the pipe after the hydrogen gas is forcibly fed. Buckling of the flexible pipe is generated by elongation of the flexible pipe in the underground space by pressure that occurs when hydrogen gas is forcibly fed. Buckling of the flexible pipe occurs between a duct portion and an underground space fixing portion in which a fixture is installed. Buckling means that when a load applied to a structure is increased, a pattern of deformation is suddenly changed by a certain load, and a large deflection occurs. Therefore, a challenge is to suppress the occurrence of buckling caused by the elongation of the flexible pipe in an underground space having no binding force such as soil.

An object of the present invention, which has been made in view of such circumstances, is to suppress buckling of the flexible pipe in an underground space during the forcible feeding of gas.

### Solution to Problem

In order to solve the above problem, a pipe clamping tool according to a present embodiment is a pipe clamping tool configured to suppress buckling of a pipe in an underground space, the pipe forcibly feeding gas, and include: a pair of fixing members that are each fixed to a side wall of the ground space and are arranged opposite to each other to clamp the pipe; and a covering material mounted between the pair of fixing members and the pipe and covering an outer periphery of the pipe.

In order to solve the above problem, a pipe clamping method according to the present embodiment is a pipe clamping method configured to suppress buckling of a pipe in an underground space, the pipe forcibly feeding gas, and include the steps of: covering an outer periphery of the pipe with a covering material; clamping the covered pipe with a pair of fixing members from both sides; fixing each of the pair of fixing members to a side wall of the underground space; determining whether or not a pressure of the gas inside the pipe in a consumption-side tank that is measured by a pressure gauge is equal to or higher than a threshold; and determining that buckling of the pipe has occurred when the pressure of the gas is lower than the threshold.

### Advantageous Effects of Invention

According to the present disclosure, the occurrence of buckling can be prevented by suppressing the elongation of the pipe after the gas is forcibly fed.

### BRIEF DESCRIPTION OF DRAWINGS

FIG. 1 is a diagram for explaining an example of a gas supply pipeline according to a present embodiment;

FIG. 2 is a diagram showing a configuration example of a pipe clamping tool according to the present embodiment.

FIG. 3 is a cross-sectional view of the pipe clamping tool according to the present embodiment.

FIG. 4 is a diagram showing a configuration example of a fixing member according to the present embodiment.

FIG. 5 shows a front view, a plan view, and a side view of the fixing member according to the present embodiment.

FIG. 6 is a diagram showing a state of a pipe prior to and after gas is forcibly fed.

FIG. 7 is a flowchart showing an example of a pipe clamping method for suppressing buckling of the pipe according to the present embodiment.

FIG. 8 is a diagram for explaining an example of a hydrogen pipeline laid through a plurality of underground spaces.

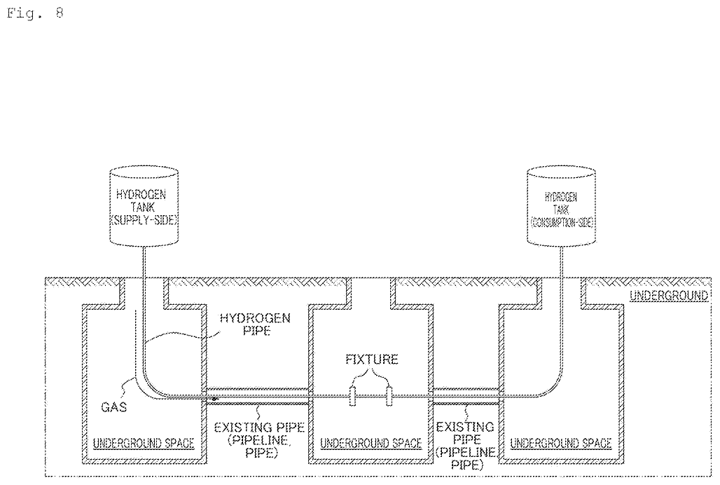

FIG. 9 is a diagram showing buckling of the pipe after hydrogen gas is forcibly fed.

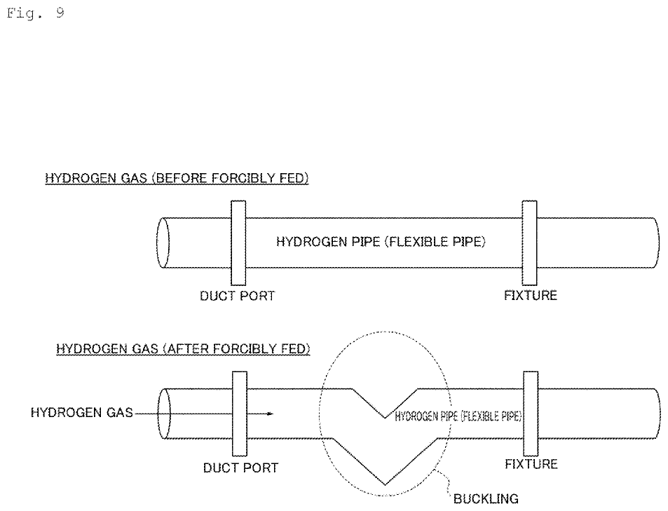

### DESCRIPTION OF EMBODIMENTS

Hereinafter, a mode for implementing the present invention will be described in detail with reference to the drawings. The present invention is not limited to the following embodiment below and can be performed by modifying it without departing from the scope of the gist of the present invention. In the present embodiment, hydrogen gas is described as an example of gas to be force-fed, but the gas to be force-fed is not limited to hydrogen gas.

### Gas Supply Pipeline

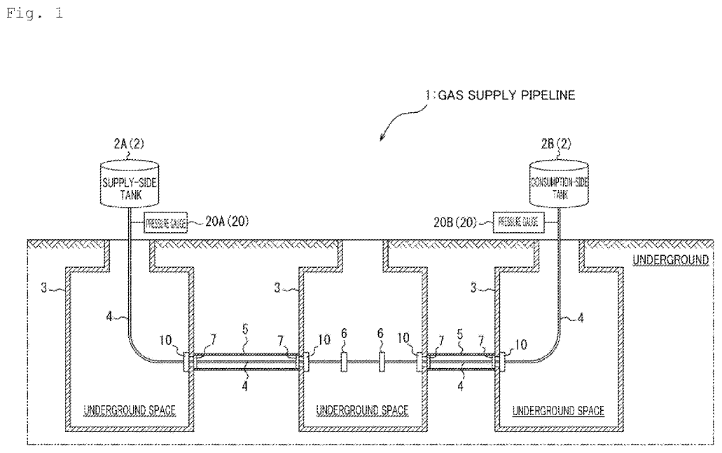

FIG. 1 is a diagram for explaining an example of a gas supply pipeline 1 according to the present embodiment. The gas supply pipeline 1 includes a supply-side tank 2A, a consumption-side tank 2B, a pressure gauge 20, an underground space 3, a pipe 4, an existing pipe 5, a fixture 6, and a duct portion 7. The gas supply pipeline 1 transports and supplies gas (for example, hydrogen gas) stored in the supply-side tank 2A installed on the ground, to the consumption-side tank 2B installed on the ground by using the pipe 4 as a transport pipeline, the pipe 4 being laid through a plurality of underground spaces 3 connected by existing pipes 5.

The supply-side tank 2A is a tank for storing gas such as hydrogen gas. The consumption-side tank 2B is a tank installed in a consumption area to store the gas transported from the supply-side tank 2A by using the pipe 4 as a transport pipeline. In the present embodiment, the supply-side tank 2A and the consumption-side tank 2B are described as being installed on the ground, but the installation thereof is not limited to the ground.

The underground spaces 3 are hollow spaces such as maintenance holes, tunnel structures, and hand holes. A duct port 7 (hereinafter referred to as a duct portion 7) for pulling in or out the pipe 4 is formed on a side wall of each underground space 3, and a pipe clamping tool 10 is fixed to a side wall in the vicinity of each duct portion 7. The underground spaces 3 are configured to take measures for preventing water such as underground water from flowing into the underground spaces 3.

The pipe 4 is a pipeline for transporting gas such as hydrogen gas. The pipe 4 is laid between the supply-side tank 2A and the consumption-side tank 2B via the inside of a plurality of underground spaces 3 connected by the existing pipe 5. A flexible pipe or the like, which is stainless steel corrugated raw pipe, is light in weight, and has a lot of flexibility, is used as the pipe 4.

The existing pipe 5 is a pipeline previously installed between two underground spaces 3. The pipe 4 is stored inside the existing pipe 5, thereby constructing a pipeline of a double pipe structure.

The fixture 6 is installed in an underground space fixing portion in order to support and fix the pipe 4 to prevent the pipe 4 from bending inside the underground spaces 3.

The duct portion 7 is a duct port penetrating wall surfaces of the underground spaces 3 in order to pull in or out the pipe 4.

Pressure gauges 20 (20A, 20B) measure gas pressures inside the pipes 4 in the supply-side tank 2A and the consumption-side tank 2B. The gas pressures inside the pipes 4 in the supply-side tank 2A and the consumption-side tank 2B are compared, and when the gas pressure inside the pipe 4 in the consumption-side tank 2B is equal to or higher than a threshold, it is determined that the pipe 4 for feeding gas is correctly constructed, and when the gas pressure inside the pipe 4 in the consumption-side tank 2B is lower than the threshold, it is determined that buckling described later has occurred in the pipe 4 inside the underground space 3. When it is determined that buckling has occurred in the pipe 4, the cause thereof is investigated to repair and the part where the problem has occurred.

### Pipe Clamping Tool

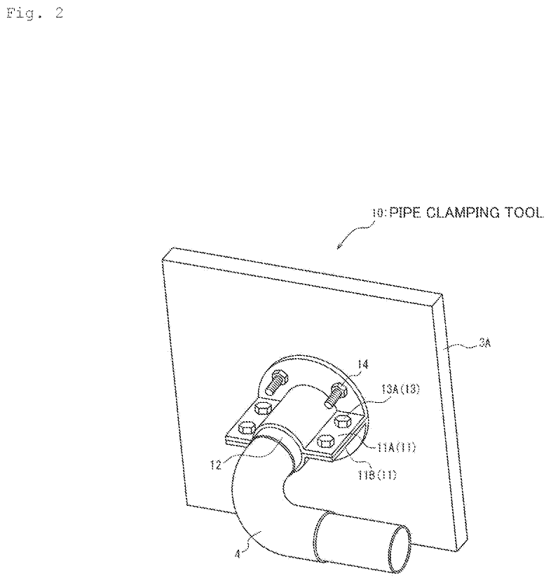

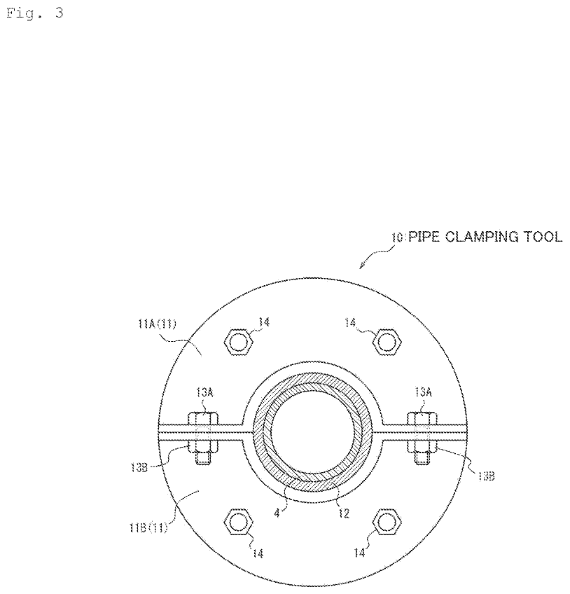

FIG. 2 is a diagram showing a configuration example of the pipe clamping tool 10 according to the present embodiment. FIG. 3 is a cross-sectional view of the pipe clamping tool 10 according to the present embodiment. As shown in FIGS. 2 and 3, the pipe clamping tool 10 includes a pair of fixing members 11, a covering material 12, one or more bolts/nuts 13, and one or more anchor bolts 14. The pipe clamping tool 10 suppresses buckling of the pipe 4 for forcibly feeding gas, in the underground space 3. One fixing member of the pair of fixing members 11 is denoted as 11A and the other fixing member is denoted as 11B. When the fixing member 11A and the fixing member 11B are not distinguished from each other, the fixing member 11A and the fixing member 11B are also described as the fixing member 11.

The pair of fixing members 11A, 11B are arranged opposite to each other across the pipe 4, and are clamped from both sides by the one or more bolts/nuts 13 (bolt 13A and nut 13B) to clamp the pipe 4. Further, the pair of fixing members 11A, 11B for clamping the pipe 4 are fixed to a side wall 3A of the underground space near the duct portion 7 by the one or more anchor bolts 14, so that force of the pipe 4 trying to stretch can be received on the surface, suppressing the pipe 4 from stretching in the underground space 3.

### Fixing Member

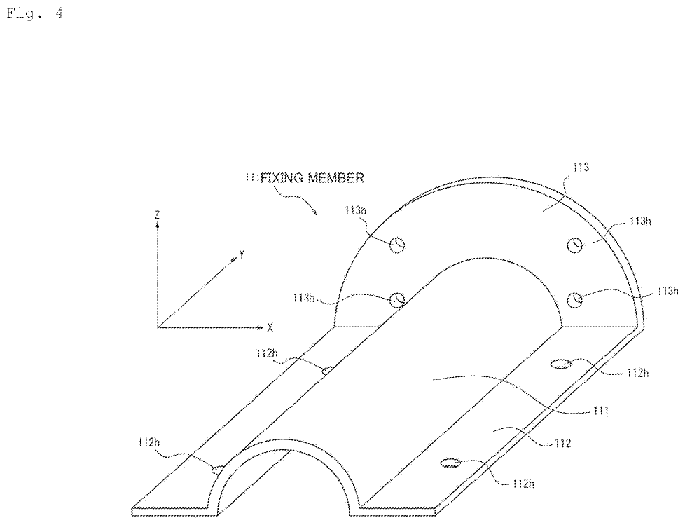

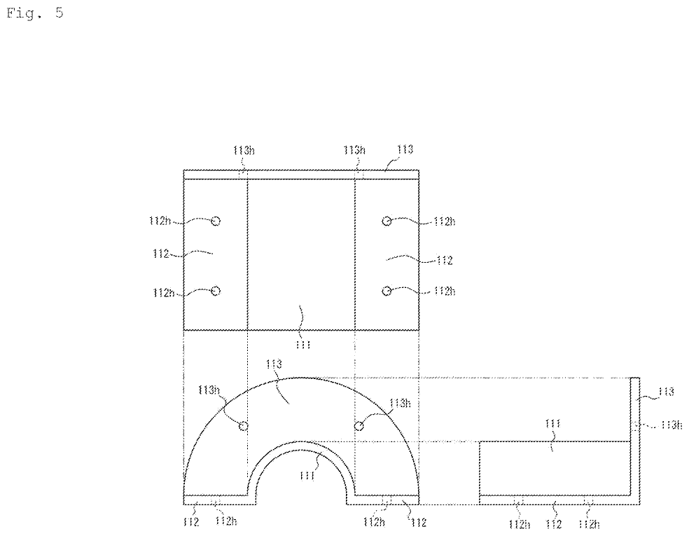

FIG. 4 is a diagram showing a configuration example of the fixing member 11 according to the present embodiment. FIG. 5 shows a front view, a plan view, and a side view of the fixing member according to the present embodiment. As shown in FIGS. 4 and 5, the fixing member 11 (11A, 11B) includes a pipe clamping portion 111, a fastening portion 112, a fixing portion 113.

The pipe clamping portion 111 has a semi-cylindrical shape obtained by dividing a cylindrical body into halves, and clamps a half circumference of an outer periphery of the pipe 4. The pipe clamping portion 111 is formed in a semi-cylindrical shape (half-cylindrical structure) obtained by dividing a cylindrical body into halves, so that the pipe clamping tool 10 can be installed even when the pipe 4 is in an existing state in the duct portion 7 of the underground spaces 3.

The fastening portion 112 is molded into a flat plate shape by being integrally molded with the pipe clamping portion 111. The fastening portion 112 is formed at either end in a first direction (denoted as an X-axis direction in FIG. 4) of the pipe clamping portion 111, and each of the fastening portions 112 has one or more bolt holes 112h.

The fixing portion 113 has a flat plate shape, and is joined to either one of ends in a second direction (denoted as a Y-axis direction in FIG. 4) of the pipe clamping portion 111 and the fastening portion 112 orthogonal to the first direction (X-axis direction). Further, the fixing portion 113 is arranged in a third direction (denoted as a Z-axis direction in FIG. 4) orthogonal to the first direction and the second direction. The fixing portion 113 also has one or more anchor bolt holes 113h. The fixing portion 113 may be joined to the pipe clamping portion 111 and the fastening portion 112 by welding, but the joining method is not limited to welding. The fixing portion 113 may be integrally molded with the pipe clamping portion 111 and the fastening portion 112 by press working or the like. In FIGS. 4 and 5, the fixing portion 113 is expressed in a semi-circular flat plate shape, but the shape of the fixing portion 113 is not limited to a semi-circular shape. The shape of the fixing portion 113 may be a polygon such as a rectangle.

The pair of fixing members 11A, 11B are preferably manufactured of the same material as the material of the pipe 4. In order to suppress the pipe 4 (flexible pipe 4) from stretching at the time of forcibly feeding the gas, it is beneficial to match the thermal expansion coefficients of the pipe 4 and the pair of fixing members 11A, 11B. The manufacturing of the pair of fixing members 11A, 11B and the pipe 4 with the same material is beneficial in suppressing the occurrence of contact corrosion by dissimilar metals.

Therefore, it is desirable that the material of the pair of fixing members 11A, 11B be the same as that of the flexible pipe 4 (SUS or the like).

The covering material 12 is mounted between the pair of fixing members 11A, 11B and the pipe 4 to cover the outer periphery of the pipe 4. The covering material 12 is preferably made of a cushioning material such as rubber in order to suppress the generation of rust due to contact corrosion of dissimilar metals between the material of the pair of fixing members 11A, 11B and the material of the pipe 4 and to suppress the damage of the pipe 4 when the covering material 12 is clamped by the pair of fixing members 11A, 11B.

The bolts/nuts 13 are attached to the one or more bolt holes 112h opened in the fastening portions 112 formed at both ends of the pair of fixing members 11A, 11B, and fasten the fixing member 11A and the fixing member 11B. Each fastening portion 112 is fastened by the one or more bolts/nuts 13 (bolt 13A and nut 13B), whereby the pair of fixing members 11A, 11B clamp the pipe 4 whose outer periphery is covered with the covering material 12.

The anchor bolts 14 are attached to the one or more anchor bolt holes 113h opened in the respective fixing portions 113 of the pair of fixing members 11A, 11B. The pair of fixing members 11A, 11B for clamping the pipe 4 are fixed to the side wall 3A of the underground space by anchor bolts 14. In order to resist the stretching of the pipe 4 by fixing the pipe clamping tool 10 with the one or more anchor bolts 14, a hole for attaching the anchor bolts 14 is installed in advance on the side wall 3A of the underground space. Since the hole opened in the side wall 3A of the underground space does not reach the back (soil) of the underground space 3, inflow of underground water does not occur. The pipe clamping tool 10 is installed so as not to interfere with a duct sleeve installed in the duct portion 7. The duct sleeve is a member forming an inlet surface of an underground space 3 (maintenance hole).

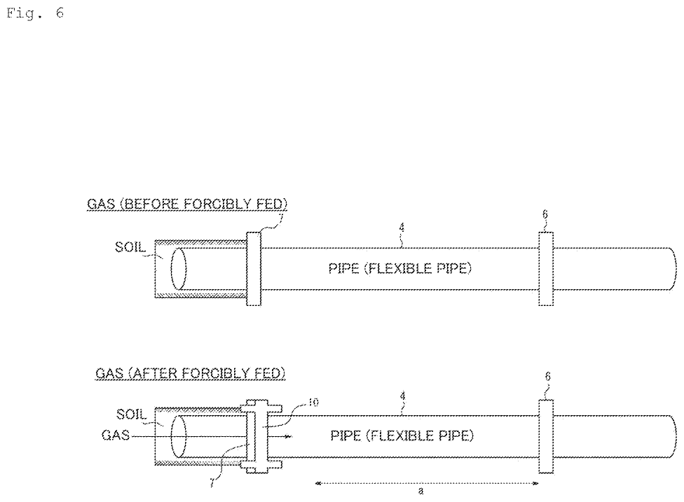

As described above, when the pipe 4 for force-feeding gas into the underground space 3 is installed, (i) the pipe clamping tool 10 clamps the outer periphery of the pipe 4 by the pipe clamping portion 111 of the half structure of the pair of fixing members 11A, 11B, and then (ii) the pipe clamping tool 10 is fixed to the side wall 3A of the underground space by the plane-shaped fixing portion 113. In this manner, the pipe clamping tool 10 can serve a projection (elongation) prevention function. FIG. 6 is a diagram showing a state of the pipe prior to and after gas is forcibly fed. As shown in FIG. 6, after the gas is forcibly fed, the pipe clamping tool 10 is fixed in the vicinity of the duct portion 7, so that, in an area a between the duct portion 7 and the underground space fixing portion where the fixture 6 is installed, buckling of the pipe 4 can be suppressed.

### Pipe Clamping Method

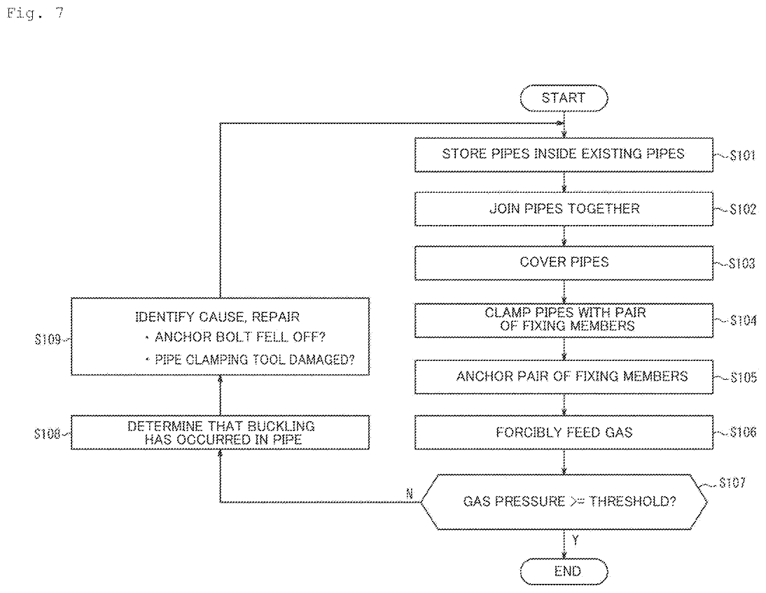

FIG. 7 is a flowchart showing an example of the pipe clamping method for suppressing buckling of the pipe 4 according to the present embodiment.

In step S101, a worker stores the pipes 4 for gas transportation in the existing pipes 5.

In step S102, the worker joins the pipes 4 to each other. The pipes 4 have a length limit in the standard. Thus, a plurality of pipes 4 are joined as necessary to secure a distance from the supply-side tank 2A to the consumption-side tank 2B via the plurality of underground spaces 3.

In step S103, the worker covers the outer peripheries of the pipes 4 at portions clamped by the pair of fixing members 11, with the covering material 12.

In step S104, the worker clamps the pipes 4 by the pair of fixing members 11.

In step S105, the worker fixes the pair of fixing members clamping the pipes 4 to the side walls 3A of the underground spaces by the anchor bolts 14.

In step S106, the worker forcibly feeds gas to the pipes 4.

In step S107, the worker compares measured values that are obtained by measuring gas pressures of the supply-side tank 2A and the demand-side tank 2B by the pressure gauge 20, and measures whether or not the gas pressure inside the pipe 4 in the consumption-side tank 2B is equal to or higher than a threshold. When the gas pressure inside the pipe 4 in the consumption-side tank 2B is lower than the threshold, the processing proceeds to step S108, and when the gas pressure is equal to or higher than the threshold, the clamping work of the pipes is finished.

In step S108, the worker determines that buckling has occurred in the pipe 4 on the basis of the fact that the gas pressure inside the pipe 4 in the consumption-side tank 2B falls below the threshold.

In step S109, the worker investigates whether the anchor bolts 14 fell off or the pipe clamping tool 10 is damaged etc., to identify the cause of the occurrence of buckling. When the cause of buckling is identified, the processing returns to step S101, and the pipe clamping work is executed again.

According to the pipe clamping tool 10 according to the present disclosure, it is possible to prevent the occurrence of buckling by suppressing the pipe from stretching after forcibly feeding gas. Further, by preventing the occurrence of buckling, an opening of a hole in the pipe 4 is prevented, and the risk of the occurrence of an explosion accident or the like due to a leakage of gas such as hydrogen gas can be reduced. Further, according to the pipe clamping tool 10, the number of times required to perform repairs and the like can be reduced, and an economical effect can be improved.

Regarding the above embodiment, the following supplemental notes are further disclosed.

### Supplemental Item 1

A pipe clamping tool configured to suppress buckling of a pipe in an underground space, the pipe forcibly feeding gas, the pipe clamping tool comprising: a pair of fixing members that are each fixed to a side wall of the ground space and are arranged opposite to each other to clamp the pipe; and a covering material mounted between the pair of fixing members and the pipe and covering an outer periphery of the pipe.

### Supplemental Item 2

The pipe clamping tool according to supplemental item 1, wherein the pair of fixing members is configured to include: a pipe clamping portion that clamps a half of the outer periphery of the pipe and has a semi-cylindrical shape obtained by dividing a cylindrical body into halves; flat plate-shaped fastening portions that are formed at both ends of a first direction of the pipe clamping portion by being integrally molded with the pipe clamping portion and that each have one or more bolt holes; and a flat plate-shaped fixing portion that is joined to one of ends in a second direction of the pipe clamping portion and the fastening portions orthogonal to the first direction and has one or more bolt holes.

### Supplemental Item 3

The pipe clamping tool according to supplemental item 1 or 2, wherein the pair of fixing members clamp the pipe having the outer periphery thereof covered with the covering material, by fastening the respective fastening portions with one or more bolts/nuts.

### Supplemental Item 4

The pipe clamping tool according to any one of supplemental items 1 to 3, wherein each of the pair of fixing members is fixed to the side wall of the underground space by an anchor bolt.

### Supplemental Item 5

The pipe clamping tool according to any one of supplemental items 1 to 4, wherein the pair of fixing members are made of the same material as the pipe.

### Supplemental Item 6

The pipe clamping tool according to any one of supplemental items 1 to 5, wherein a material of the covering material is rubber.

### Supplemental Item 7

A pipe clamping method configured to suppress buckling of a pipe in an underground space, the pipe forcibly feeding gas, the pipe clamping method comprising the steps of: covering an outer periphery of the pipe with a covering material; clamping the covered pipe with a pair of fixing members from both sides; fixing each of the pair of fixing members to a side wall of the underground space; determining whether or not a pressure of the gas inside the pipe in a consumption-side tank that is measured by a pressure gauge is equal to or higher than a threshold; and determining that buckling of the pipe has occurred when the pressure of the gas is lower than the threshold.

Although the above-described embodiment has been introduced as a representative example, it is clear for a person skilled in the art that many alterations and substitutions are possible within the gist and scope of the present disclosure.

Therefore, the present invention should not be interpreted as being limited by the foregoing embodiment and can be modified or altered in various ways without departing from the scope of the claims.

### REFERENCE SIGNS LIST

1 Gas supply pipeline
2A Supply-side tank
2B Consumption-side tank
3 Underground space
3A Sidewall of underground space
4 Pipe (flexible pipe)
5 Existing pipe
6 Fixture
7 Duct portion (duct port)
10 Pipe clamping tool
11, 11A, 11B Fixing member
12 Covering material
13 Bolt/nut
13A Bolt
13B Nut
14 Anchor bolt
20, 20A, 20B Pressure gauge
111 Pipe clamping portion
112 Fastening portion
112h Bolt hole
113 Fixing portion
113h Anchor bolt hole

1. A pipe clamping tool configured to suppress buckling of a pipe in an underground space, the pipe clamping tool comprising:
a pair of fixing members, respective fixing members of the pair of fixing members being fixed to a side wall of the underground space and arranged opposite to each other to clamp the pipe, the pipe forcibly feeding gas, and the pipe traverses the underground space; and
a covering material mounted between the pair of fixing members and the pipe, the covering material covering an outer periphery of the pipe, and thereby a combination of the pair of fixing members and the covering material suppressing buckling of the pipe caused by a pressure of the forcibly fed gas inside the pipe.

2. The pipe clamping tool according to claim 1, wherein the pair of fixing members is further configured to comprise:
a pipe clamping portion, the pipe clamping portion clamps a half of the outer periphery of the pipe and has a semi-cylindrical shape obtained by dividing a cylindrical body into halves;
flat plate-shaped fastening portions at both ends of a first direction of the pipe clamping portion, the flat plate-shaped fastening portions being integrally molded with the pipe clamping portion, and respective plate-shaped fastening portions of the flat plate-shaped fastening portions comprises one or more bolt holes; and
a flat plate-shaped fixing portion that is joined to one of ends in a second direction of the pipe clamping portion, and the fastening portions orthogonal to the first direction and has one or more bolt holes.

3. The pipe clamping tool according to claim 2, wherein the pair of fixing members clamps the pipe having the outer periphery thereof covered with the covering material, by fastening the respective fastening portions with one or more pairs of a bolt and a nut.

4. The pipe clamping tool according to claim 3, wherein each of the pair of fixing members is fixed to the side wall of the underground space by an determined pressure anchor bolt.

5. The pipe clamping tool according to claim 4, wherein the pair of fixing members are made of the same material as the pipe.

6. The pipe clamping tool according to claim 5, wherein a material of the covering material comprises rubber.

7. A method for clamping a pipe, comprising:
covering, by a covering material, an outer periphery of the pipe, the pipe forcibly feeding gas, and the pipe traverses an underground space;
clamping the covered pipe with a pair of fixing members from both sides of the covered pipe;
fixing each of the pair of fixing members to a side wall of the underground space, and thereby a combination of the pair of fixing members and the covering material suppressing buckling of the pipe caused by a pressure of the forcibly fed gas inside the pipe;
determining a pressure of the forcibly fed gas inside the pipe in a consumption-side tank that is measured by a pressure gauge as being equal to or higher than a threshold; and
determining, based the determined pressure of the forcibly fed gas and the threshold, buckling of the pipe has occurred.

8. The pipe clamping tool according to claim 6, wherein the pipe connects from a gas supply tank on a first end of the pipe, the pipe connects to a consumption-side tank on a second of the pipe, and the forcibly fed gas, flows from the gas supply tank to the consumption-side tank through the pipe.

9. The pipe clamping tool according to claim 8, wherein the forcibly fed gas comprises a hydrogen gas.

10. The pipe clamping tool according to claim 8, wherein the covering material reduces an occurrence of rust caused by contact corrosion of dissimilar materials between a first material of the pair of fixing members and a second material of the pipe.

11. The method according to claim 7,
wherein the pair of fixing members is further configured to comprise:
a pipe clamping portion, the pipe clamping portion clamps a half of the outer periphery of the pipe and has a semi-cylindrical shape obtained by dividing a cylindrical body into halves;
flat plate-shaped fastening portions at both ends of a first direction of the pipe clamping portion, the flat plate-shaped fastening portions being integrally molded with the pipe clamping portion, and respective plate-shaped fastening portions of the flat plate-shaped fastening portions comprises one or more bolt holes; and
a flat plate-shaped fixing portion that is joined to one of ends in a second direction of the pipe clamping portion, and the fastening portions orthogonal to the first direction and has one or more bolt holes.

12. The method according to claim 7, wherein the pair of fixing members clamps the pipe having the outer periphery thereof covered with the covering material, by fastening the respective fastening portions with one or more pairs of a bolt and a nut,
each of the pair of fixing members is fixed to the side wall of the underground space by an anchor bolt,
the pair of fixing members are made of the same material as the pipe,
the pipe is flexible,
the forcibly fed gas comprises a hydrogen gas, and
the pressure of the forcibly fed gas is lower than the threshold.

13. The method according to claim 12,
wherein the pipe connects from a gas supply tank on a first end of the pipe, the pipe connects to the consumption-side tank on a second of the pipe, and
the forcibly fed gas flows from the gas supply tank to the consumption-side tank through the pipe.

14. The method according to claim 13,
wherein the underground space is a waterproof to prevent water leakage from outside the underground space, and
the pipe is flexible.

15. The method according to claim 14,
wherein the covering material reduces an occurrence of rust caused by contact corrosion of dissimilar materials between a first material of the pair of fixing members and a second material of the pipe.
